(19) United States
(12) Patent Application Publication
(10) Pub. No.: US 2007/0276712 A1
(43) Pub. Date: Nov. 29, 2007

(54) Project size estimation tool

(76) Inventors: Renjeev V. Kolanchery, Bangladore (IN); Harish Ranganath, Bangladore (IN)

Correspondence Address: ACCENTURE CHICAGO 28164;BRINKS HOFER GILSON & LIONE, P O BOX 10395, CHICAGO, IL, 60610, US

(21) Appl. No.: 11/439,606

(22) Filed: May 24, 2006

(51) Int. Cl. G06F 17/50

(52) U.S. Cl. 705/7

(57) ABSTRACT

A tool estimates the size of a computer-related project. Transaction function points are quantified regarding transactions against files or data in the computer-related project. Data function points are quantified regarding files used to store data for the computer-related project. An unadjusted function point is calculated in accordance with the transaction function point and data function point. A value adjustment factor is determined as modified for a particular implementation. An adjusted function point is calculated in accordance with the unadjusted function point and the value adjustment factor. The size of the computer-related project is estimated in accordance with the adjusted function point.

### TECHNICAL FIELD

Generally a tool is disclosed for estimating the size of a project, and more particularly a tool that may be used to estimate the size of computer related project such as a data warehouse project.

### BACKGROUND

For systems and/or projects, a user may want to determine a size of a project/product to be delivered. Sizing or estimation may be important to facilitate a prediction of the effort or time associated with project development. To date, a standard software size for software development is lines of code (LOC). The generated code may cause a discrepancy, however, in the size estimation because the code may be dependent upon a number of mapped elements. Also, the correlation between business rules, interfaces, or workflows may be relatively weak. Therefore, the size may be a skewed function of mapped elements.

Currently, there is no known standard technique for estimating the size of certain projects. An existing way to estimate certain projects is based on an experience of the people involved in the project. There is a human element with such size estimation, however, and estimations may vary from person to person. The ability to provide consistent size estimation may be a problem since size estimation may vary depending on the person's experience, ability and capability.

There may also be a problem with other techniques such as Feature Point, Use Cases, and Size & Complexity to measure the size of certain projects. The Feature Point or Use Cases approaches are typically cannot be used unless the features/use cases are easily identified on the basis of a flow of information. In addition, while Size & Complexity may be used to estimate certain projects, the same drawback may apply as with experienced based estimation in that such estimation includes implicit assumptions that may not be true.

### BRIEF SUMMARY

A tool is disclosed for estimating the size of a computer-related project. Transaction function points are quantified regarding transactions against files or data in the computer-related project. Data function points are quantified regarding files used to store data for the computer-related project. An unadjusted function point is calculated in accordance with the transaction function point and data function point. A value adjustment factor is determined as modified for a particular implementation. An adjusted function point is calculated in accordance with the unadjusted function point and the value adjustment factor. The size of the computer-related project is estimated in accordance with the adjusted function point.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a block diagram illustrating a general computer system of the tool.

FIG. 2 is a table illustrating external inputs for a Function Point analysis.

FIG. 3 is a table illustrating external outputs and external inquiries for a Function Point analysis.

FIG. 4 is a table illustrating external inputs, external outputs and external inquiries for a Function Point.

FIG. 5 is a table illustrating internal logical files and external interface files for a Function Point analysis.

FIG. 6 is a table illustrating internal logical files and external interface files for a Function Point.

FIG. 7 is a flowchart illustrating an exemplary Function Point estimation process for data warehousing.

FIG. 8 is a table showing general characteristics of the value adjustment factor.

### DETAILED DESCRIPTION

A system, method and tool, hereinafter referred to generally as a tool, is disclosed that may be used to estimate a size of a project, such as a computer related project. The tool may incorporate Function Point analysis to arrive at a standard way of sizing the projects, e.g., as a weighted function of the attributes of the project. In one example, the sizing technique may be used to determine the size for extraction-transformation-loading (ETL) or other parts of data warehousing. The tool may be customized to suit the ETL or other size estimations, depending on an implementation. The tool may also be used to estimate the size of other projects such as data warehousing projects involving other ETL tools such as Abinitio/Data stage or the reporting tools such as Business Objects/Cognos, and projects that utilize tools such as informatica and business objects. The tool may consider multiple variables such as effort, productivity and size. A value adjustment factor may be calculated based on determined characteristics and used to obtain a more accurate estimate.

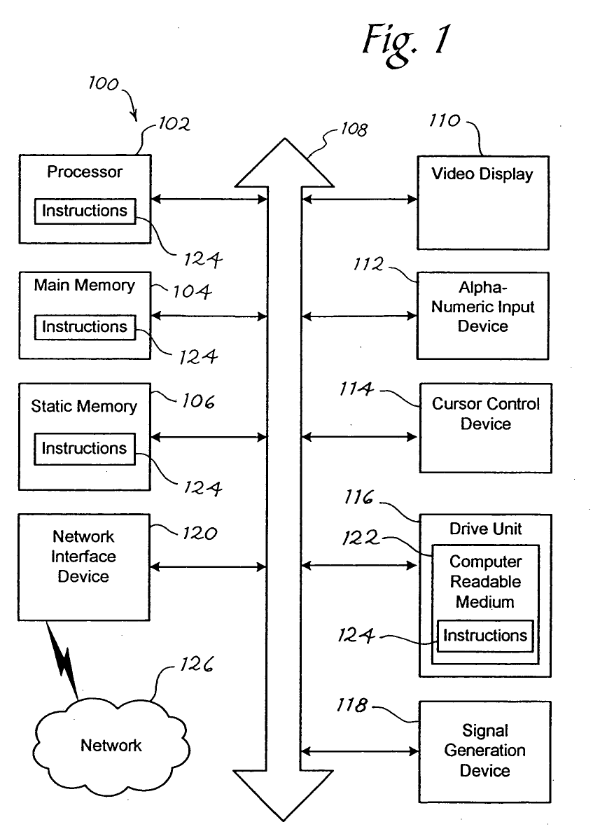

FIG. 1 illustrates a general computer system 100 of the tool. The computer system 100 may include a set of instructions that can be executed to cause the computer system 100 to perform any one or more of the methods or computer based functions disclosed herein. The computer system 100 may operate as a standalone device or may be connected, e.g., using a network, to other computer systems or peripheral devices. The tool may be implemented hardware, software or firmware, or any combination thereof. Alternative software implementations may be used including, but not limited to, distributed processing or component/object distributed processing, parallel processing, or virtual machine processing may also be constructed to implement the tools described herein.

In a networked deployment, the computer system 100 may operate in the capacity of a server or as a client user computer in a server-client user network environment, or as a peer computer system in-a peer-to-peer (or distributed) network environment. The computer system 100 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, or any other machine capable of executing a set of instructions (sequential or otherwise) that specify actions to be taken by that machine. The computer system 100 may be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

In FIG. 1, the computer system 100 may include a processor 102, e.g., a central processing unit (CPU), a graphics processing unit (GPU), or both. Moreover, the computer system 100 may include a main memory 104 and a static memory 106 that may communicate with each other via a bus 108. The computer system 100 may further include a video display unit 110, such as a liquid crystal display (LCD), an organic light emitting diode (OLED), a flat panel display, a solid state display, or a cathode ray tube (CRT). Additionally, the computer system 100 may include an input device 112, such as a keyboard, and a cursor control device 114, such as a mouse. The computer system 100 may also include a disk drive unit 116, a signal generation device 118, such as a speaker or remote control, and a network interface device 120.

In FIG. 1, the disk drive unit 116 may include a computer-readable medium 122 in which one or more sets of instructions 124, e.g. software, may be embedded. Further, the instructions 124 may embody one or more of the methods or logic as described herein. In a particular embodiment, the instructions 124 may reside completely, or at least partially, within the main memory 104, the static memory 106, and/or within the processor 102 during execution by the computer system 100. The main memory 104 and the processor 102 also may include computer-readable media.

Dedicated hardware implementations, such as application specific integrated circuits, programmable logic arrays and other hardware devices, may be constructed to implement one or more of the tools described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit.

The present disclosure contemplates a computer-readable medium that includes instructions 124 or receives and executes instructions 124 responsive to a propagated signal, so that a device connected to a network 126 may communicate voice, video or data over the network 126. Further, the instructions 124 may be transmitted or received over the network 126 via the network interface device 120. While the computer-readable medium is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding or carrying a set of instructions for execution by a processor or that cause a computer system to perform any one or more of the methods or operations disclosed herein.

The computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

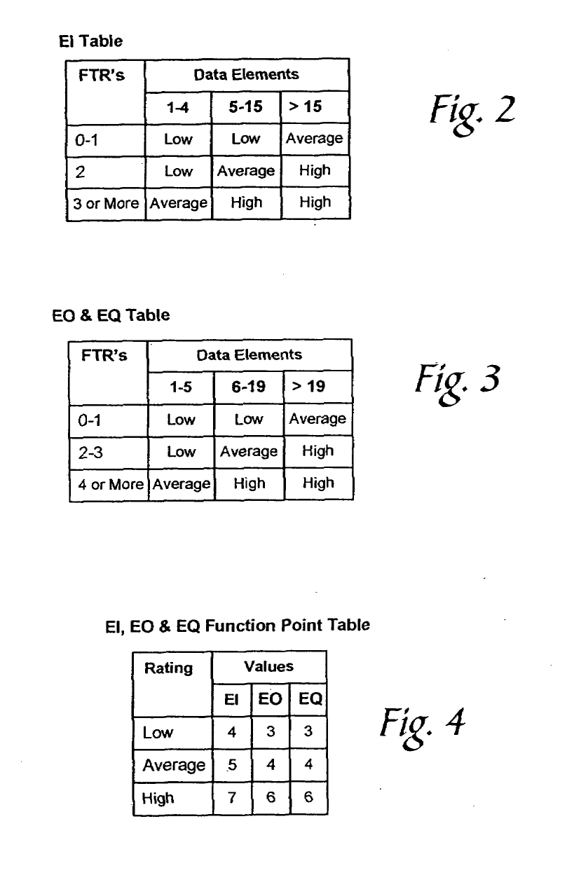

FIGS. 2-6 are tables that illustrate five exemplary classes in Function Point analysis. Function Point analysis is a structured technique of problem solving. The tool may use Function Point analysis to estimate a size of an application/project. The Function Point analysis divides systems into smaller components, so they may be better understood and analyzed. Function Points measure systems from a functional perspective and thus the analysis may be independent of the technology being analyzed. Function points may be used by the tool to estimate effort associated with software development. An International Function Point Users Group (IFPUG) was established and several versions of the Function Point Counting Practices Manual have been published by IFPUG, the current version of which is IFPUG Manual 4.1, which is incorporated by reference herein.

Regardless of a language, development method, or hardware platform used, the number of Function Points for a given system remains constant. The only variable is the effort needed to deliver a given set of function points. Therefore, the tool may use Function Point analysis to determine whether a tool or a language is more productive compared with others. Since Function Point may provide a substantially accurate size of a project, a subsequent analysis may provide a mechanism to track and monitor scope creep, e.g., additional changes as compared to the initial requirements. The Function Points estimated for each phase may be compared to the Function Points actually delivered, and any variance may be used to trigger a root cause analysis, which may further strengthen the estimation process. Variance includes effort and schedule. Any type of variance, either positive or negative, may point to either underestimation or overshoot and this may be justified and considered as a learning/corrective measure for the future projects. The Function Point analysis with the tool may provide very close estimates to actual size, such as with about 5-9% of variation.

Using Function Point analysis, systems may be divided into classes and general system characteristics. The tool may divide a given project/application into data Function Points and transaction Function Points. In the following example, for illustrative purposes, five classes are used, but other amounts of classes may be used. If five classes are used, the first three classes may be divided into External Inputs (EI), External Outputs (EO), and External Inquires (EQ). Each of these classes may involve transaction against files/data, and therefore may be referred to as transactions. The next two classes, Internal Logical Files (ILF) and External Interface Files (EIF), include files that may be used to store data which may be combined to form logical information, and therefore may be referred to as data sources. The general system characteristics may assess the general functionality of the system, as explained in more detail below, such as with regard to Table 1.

FIGS. 2-4 illustrate exemplary transaction Function Points. External Inputs (EI) may denote the process in which data crosses a boundary from outside to inside. This data may come from a data input screen or another application. The data may be used to maintain one or more internal logical files. The data may be either control information or business information. If the data is control information it does not have to update an internal logical file. In other words, an intent of the process may be to either alter the behavior or change the state of the system.

An EI may be identified such that 1) the data or control information is received from outside the application boundary; 2) at least one internal logic file (ILF) is maintained if the data entering the boundary is not control information that alters the state or behavior of the system; or 3) processing logic is unique from the processing logic performed by the other EI's for the application such that, i) the set of data elements identified is different from the sets identified for other EI's for the application, or ii) the ILF's or EIF's referenced are different from the files referenced by other external inputs in the application.

External Outputs (EO) may denote an elementary process in which derived data passes across the boundary from an inside of the application boundary to an outside environment. Additionally, an EO may update an ILF. The data typically creates reports or output files sent to other applications. These reports and files may be created from one or more internal logical files and external interface file. In other words, the system may process the data for user consumption and it may also alter the behavior or change the state of the system.

An EO may be identified such that 1) the function sends data or control information external to the application boundary; 2) the Processing logic is unique from the processing logic performed by other EO's for the application, such that i) the set of data elements identified is different from the sets identified for the other EO's in the application, or ii) the ILF's or EIF's referenced are different from the files referenced by the other EO's in the application; 3) The processing logic of the elementary process contains at least one mathematical formula or calculation, such that i) the processing logic of the elementary process creates derived data, ii) the processing logic of the elementary process maintain at least one ILF, or iii) the processing logic of the elementary process alters the behavior of the system.

External Inquiry (EQ) may denote an elementary process with both input and output components that result in data retrieval from one or more internal logical files and external interface files. The input process does not update any Internal Logical Files, and the output side does not contain derived data. An EQ may be identified such that 1) the function sends data or control information external to the application boundary; 2) the processing logic is unique from the processing logic performed by other EQ's for the application, such that i) the set of data elements identified is different from the sets identified for the other EQ's in the application, or ii) the ILF's or EIF's referenced are different from the files referenced by the other EQ's in the application; 3) the processing logic of the elementary process does not contain a mathematical formula or calculation, such that i) the processing logic of the elementary process retrieves data or control information from an ILF or EIF, ii) the processing logic of the elementary process does not create derived data, iii) the Processing logic of the elementary process does not maintain at least one ILF, or iv) the processing logic of the elementary process does not alter the behavior of the system.

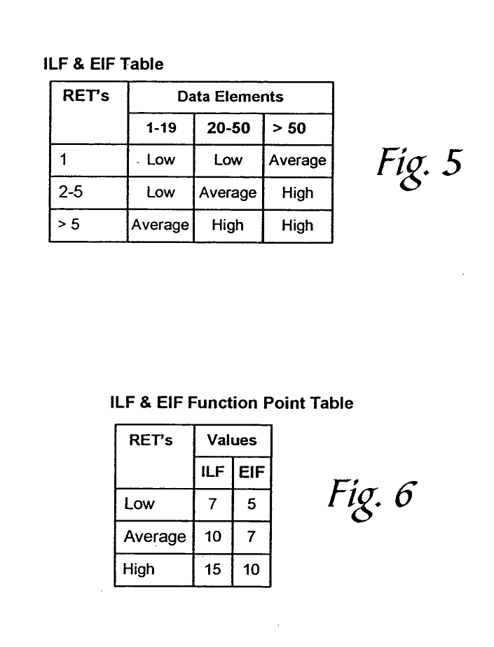

FIGS. 5 and 6 illustrate exemplary data Function Points. The Internal Logical Files (ILF) may denote a user identifiable group of logically related data that resides entirely within the applications boundary and is maintained through external inputs/external outputs. The External Interface Files (EIF) may denote a user identifiable group of logically related data that is used for reference purposes. The data may reside entirely outside the application and may be maintained by another application. The external interface file may be an internal logical file for another application.

After the components of the project and/or process have been classified as one of the five components (EI's, EO's, EQ's, ILF's or EIF's), a ranking of low, average or high may assigned. For transactions (EI's, EO's, EQ's) the ranking may be based upon the number of files updated or referenced (FTR's) and the number of data element types (DET's). For both ILF's and EIF's files the ranking may be based upon record element types (RET's) and data element types (DET's). A record element type includes a user recognizable subgroup of data elements within an ILF or EIF. A data element type may include a unique user recognizable field. The field may denote a related column in a database.

As an example implementation, an EI with more than 15 data elements and FTR's of 3 or more may be assigned a ranking of High. (FIG. 2). An EO or EQ of 6 to 19 data elements with an FTR of 2 or 3 may obtain an Average rank. (FIG. 3). An ILF or EIF of 1 to 19 data elements and RET's of 2 to 5 may receive a Low ranking. The ranking of Low, Average and High translates into Function Points, such as described below with regard to FIG. 4. Thereafter, the count of Function Points may be taken for all the five classes. (FIGS. 4 and 6). The total of all these Function Points may constitute the Total Number of Unadjusted Function Points (UAF).

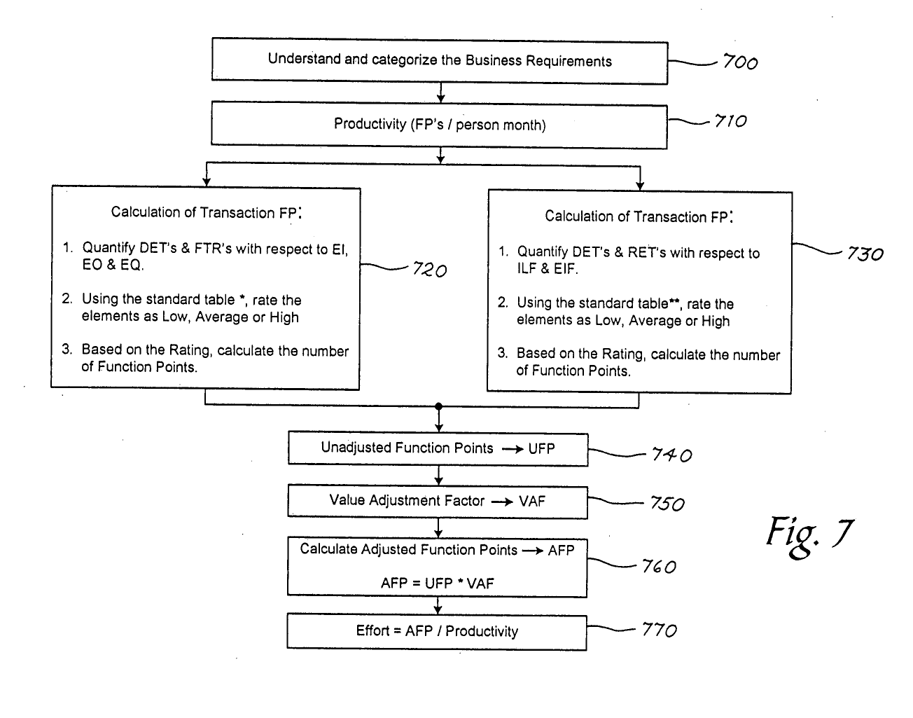

FIG. 7 is a flowchart illustrating an exemplary Function Point Estimation process for data warehousing. At block 700, the business requirements are understood and categorized. The categorization may include a high level business requirement such as “Build a Finance Data Mart to aid the functioning of the Finance team”. At block 710, productivity is calculated. The productivity may be the Function Points per person month based on the technologies involved, such as per the industry standards.

At blocks 720 and 730, the transaction Function Points and the data Function Points are calculated. At block 720, to calculate the transaction Function Points, the DET's and FTR's are quantified with respect to EI, EO and EQ. The elements are rated as Low, Average or High, such as by using the tables shown in FIGS. 2-4. Based on the rating, the number of transaction Function Points is calculated. At block 730, the data Function Points are calculated. The data Function Points may be calculated before, after or at the same time as the transaction Function Points. To calculate the data Function Points, the DET's and RET's may be quantified with respect to the ILF and EIF. The elements are rated as Low, Average or High, such as by using the tables shown in FIGS. 5-6. The number of data Function Points may be calculated based on the rating.

Thereafter, an estimate of effort may be determined. To calculate effort, at block 740, an Unadjusted Function Point (UFP) is determined by summing the transaction and data Function Points. At block 750, to account for general system characteristics that may influence the complexity of a given application, a Value Adjustment Factor (VAF) may be determined, as discussed in more detail below. At block 760, an Adjusted Function Point (AFP) may be calculated as the UFP multiplied by VAF. At block 770, an estimate of Effort may be arrived at as the AFP divided by Productivity. Productivity may be determined as discussed in block 710, such as based on the technologies involved, as per the industry standards, to calculate the Productivity (FP's/person month).

AFP=UAF*VAF EQUATION 1:

Effort=AFP/Productivity EQUATION 2:

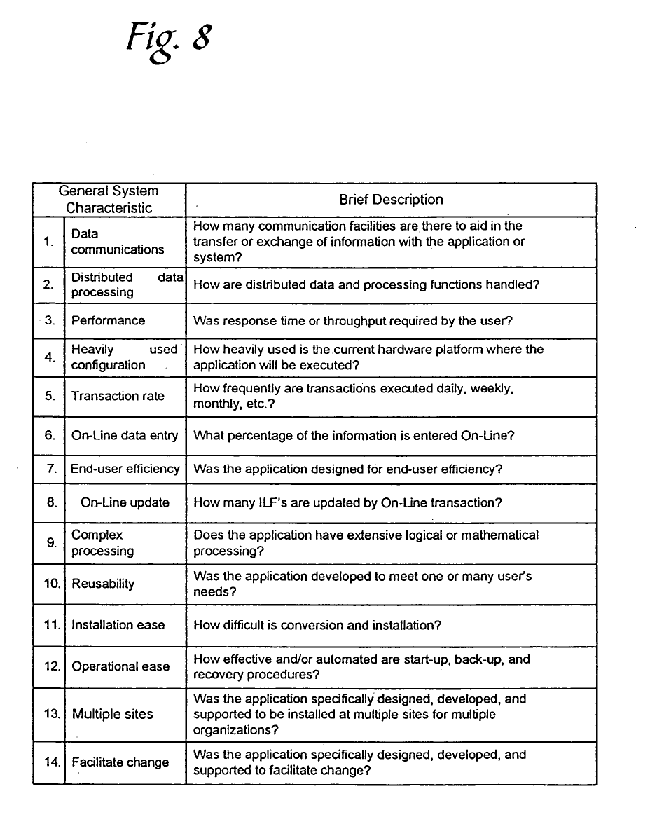

FIG. 8 is a table illustrating exemplary general system characteristics for determining a Value Adjustment Factor (VAF). Initial categorization of functionality under data and transaction Function Points typically yields unadjusted function points since general system characteristics have not yet been accounted for, which may influence the complexity of given application. The ranking/weight on these factors may yield a Degree of Influence, which in turn may help in arriving at the Value Adjustment Factor (VAF).

The Value Adjustment Factor (VAF) may be based on the General System Characteristics (GSC's) shown in FIG. 8, or other characteristics as discussed in more detail below. The GSC's rate the general functionality of the application being counted. Each characteristic has associated descriptions that help determine the degrees of influence of the characteristics. The degrees of influence may range on a scale of zero to five, from no influence to strong influence. The IFPUG Counting Practices Manual provides evaluation criteria for each of the GSC'S. The table in FIG. 8 provides an overview of each GSC.

After the General System Characteristics have been answered, they may be tabulated using the IFPUG Value Adjustment Equation (VAF).

VAF=0.65+[(å Ci)/100] EQUATION 3:

Where Ci=Degree of Influence for each General System Characteristic (GSC); i=Ranges from 1 to 14, representing each GSC; å=Summation of all the GSC. A final Function Point Count may be obtained by multiplying the VAF with the Unadjusted Function Point (UAF) such that the Adjusted Function Point equals UAF*VAF.

The following are general estimation considerations. One, the product or process may be analyzed from a logical perspective, i.e. not by a physical state of the system. For example, deciding on data entities from a physical view, instead of the logical view, could translate one entity into two or more entities. Similarly, when the application boundary is stated or defined, this may not be confused with the same with physical infrastructure. For example, one physical machine may house two different systems, so the user may define the scope as per application scope, and not by physical location of resources.

Two, the transaction may be considered a set of tasks/activities/steps, which are performed in order to achieve the end objective. In other words, a transaction may include one or more steps, and it is the end objective that determines the scope of a transaction. For example, if a requirement is to “Update Customer Information”, then a transaction may not be limited to the update alone. That is, the user may design a system such that it, a) provides search facility to a customer, b) provides an interface to show the searched result, c) provides a facility to choose a customer account, and d) provides a facility to update the information of a customer account. For example, the end result “Update of Customer Information” may be met in four steps. Therefore, the four steps may qualify for a single transaction, and not as four separate transactions.

Three, regarding intermediate files, if a process creates some intermediate files/tables, then those files/tables may not qualify either for ILF or EIF. The reason being, ultimately the intermediate files may be nothing but data, which may be stored in either a file or a table medium. The same could have also been stored in memory or some other medium. Therefore, intermediate files may be considered data, which is being produced and consumed by same transaction process.

Four, the Add/Modify/Delete operations, which can change the state or behavior of a system may translate into individual EI. However, such a translation may inflate the estimates. For example, if a transaction carries out four steps as explained in the second point, it may be considered only one transaction, though carried out in four steps. Therefore, it may be preferable to have “Search”, “Modify”, and “Delete” combined in one transaction and count as a single EO (as the user may query the existing data). The “Add” operation may be counted separately as EI.

Five, any combo box, filled via the database, that requires values from a database may qualify for a single EQ. However, this practice may result in inflated estimates. For example, if the user is building some application in J2EE, and as per industry standards the productivity ranges between 16-23 FP/Person Month. If the “combo box” filling qualifies for a simple EQ, this translates into 3 FP. Essentially, this combo box filling operation may require [(3/21)*160=22.85] person hours. Since this operation may not be worth this effort, the user may decide to not take into account any “combo box” filling operation in the estimates.

Six, regarding the ILF/EIF, unique entries may be considered, otherwise double counting may result. That is, one logical data entity may either qualify for ILF or EIF, but may not be a part of both for same application. One logical data entity may act as ILF for some transactions, and still some other transaction may require only data reference, but both are part of the same system.

Seven, when counting DET any unique object/attribute over the user interface screen or batch process may qualify for DET. That is, all information (except for static labels) originated through data storage, all action triggering objects like radio buttons, check boxes, command buttons etc., may qualify for DET. However, multiple records display may not qualify for unique information since the attribute or attributes may be the same and only the data differs. The same may also be true for batch processes.

Eight, when counting RET, the RET may be visualized as groups, i.e. if the information can be categorized into some logical groups, then each logical group may translate into one RET. For example, in the case of customer information in a bank, the tool may categorize the information into the following groups, a) Personal Information, b) Account Information, c) Contact Information, d) Loans Information, etc. Each may qualify for one RET. For the Customer entity there may be at least 4 RET (in this given example).

Nine, when counting FTR, any reference to data entity, be it ILF or EIF, may result as a reference to FTR. Therefore, the tool may restrict the counting to either ILF or EIF, instead both should be considered. This may be done with caution as reference to the data entity for one or two attributes, or when it is a part of bigger query, under those scenarios the tool may not take those into consideration for the FTR calculation.

Ten, regarding the importance of VAF, the data and transaction Function Point may only account for explicit functionality of a given system. However, system complexity and effort may also be influenced by certain environmental, quality and general factors, like, “Multi-site”, “Process Performance”, “End-User Efficiency” etc. That is why, the Function Point obtained after calculation of data and transaction Function Point, may be termed as an Unadjusted Function Point (UFP). The tool has not yet adjusted the values for these related but somewhat external factors. This adjustment may either increase or decrease the size by about 35%.

Eleven, with regard to productivity, the value of productivity in the Function Point estimation can effect the estimation. The reason being, Function Point may provide only the size of the system, which may be independent of a technology or platform. However, effort is a function of technology, and given the equation Effort=(Size/Productivity) it may be preferable to have right value for productivity. The given mathematical equation suggests that, if the productivity taken during the calculation is higher than the actual productivity, then it may result in a lower effort allocation for project. Therefore, an effort overrun may exist after the completion. On the other hand, if the productivity is understated, the user may be left with excessive resources. In either case the user may be worse off, as in first case the user may loose revenue and in second case the user may incur the opportunity cost.

Twelve, for projects involving multiple technologies, and estimation technique may take into account the productivity for such projects, as productivity is a function of technology. Under these scenarios, the tool may categorize/divide the system into smaller components, and then group those according to technologies. Once completed, the size of each sub-system may be calculated in comparison to total size of the system. This ratio may provide one with the weight that is needed to apply at the overall productivity for a given system. The tool may ignore these micro level procedures, if a given technology/platform is dominant, that is, constitutes to 85%-90% of the complete system. If so, the tool may take that productivity for the complete system as well.

Thirteen, the tool may determine Add/Modify/Delete/Search/Report/Download/E-mail/Report Cum Download such that a) Add is taken into EI; b) “Search”, “Modify”, “Delete” (linked to a single transaction”—is determined as one EO; c) Report—If it is a simple one, and has Max, Min, Ave, or other simple mathematical operations, and does not need any heavy business processing, may be determined as EQ, otherwise taken as EO; d) Any independent search facility may be counted as EQ; e) Any download operation may be included as a part of an EO, and, if the same needs to be preceded by a search operation, then search and download may both be considered a part of a single transaction, counted under EO; and f) Reports with Download facility may be considered two separate transactions since a report over the screen can serve the purpose of having access to requested details. Having, a hard/soft copy of the same may be considered another transaction.

Fourteen, when updating only few fields of a table, but not creating or deleting any information, the state of the entity may be changed, but no other operations may be accomplished such as “Add”, or “Delete”. Therefore, the given entity may not be included in either the ILF or EIF. An exception may include “Health Checks” where the statistics table may be counted as ILD.

Fifteen, to calculate for batch processes, the tool may count the attributes needed for processing (modification), and count all referenced/modified entities as FTR.

Sixteen, regarding an audit trail functionality, the tool may include this effort by sizing for the audit trail. However, if there are ten entities requiring an audit trail, the tool may not count ten EO. Instead the tool may consider re-use/generalized modules for audit trail, and size accordingly. Since the audit trails may have a common methodology, instead of counting the function points for the ten audits, the audit trails may be reduced and only two function points considered. Otherwise, an inflated estimate in terms of effort may occur. In many situations, this consideration may result in one EO.

The tool may also consider data warehouse specific estimation considerations. Regarding ELF/ILF, while designing a project, if there are tables that have been designed as a part of an earlier project that may be used only for reference in the current project, then the same may not be taken into account while counting the DET's and RET's for EIF. An example may be a Health Check project for Data Marts. A health Check is a job that, at a very broad level, compares the source and target count and accordingly sends emails related to success or failure. In such cases, the tables already exist and the effort to maintain these may have been considered during the estimation of build of the Marts. Therefore, the tool may not consider these tables as EIF. If many intermediate tables exist, which a given process creates, since these intermediate tables are “generated and consumed” by the process, these tables may not be taken into account, either under ILF or EIF. Data is part of the process but the decision to store the data under intermediate tables only acts as a medium of storage.

While computing the DET's and FTR's for EO/EI/EQ, if the calculated rating is High, the tool may decide whether the EO/EI/EQ's need to be broken down into logical groups or not. For example, where the number of DET's and FTR's are 100 and 25 respectively, this may translate into a High rating. Given the scenario where the numbers are 200 and 50, this may also translate into a High rating. The number of Function Points for a High rating may either be 7 or 6, depending on whether the given transaction has been classified as EO, EI, or EQ. From given example, in both the cases the effort estimated is the same whereas the actual effort is different in each case. Therefore, in order to remove this discrepancy and to arrive at realistic estimates, the tool breaks the given functionality into two or more sub-groups/functions. The tool may break this functionality into two “High”, one “High” and one “Low”, or any other combination, may depend on an input from the user who is requesting the estimates. The user may apply judgment, such as via application understanding, to arrive at an estimate.

Also regarding data warehousing or other projects, all queries may not qualify for EQ. For example, if the tool is estimating the size of a transaction, some database interaction, processing logic, business rules etc., may occur and all these may be considered in the EO/EI/EQ estimation. However, for complex projects, the user may choose to have the tool perform the estimates by breaking up the functionality.

The following Table 1 shows general characteristics of the value adjustment factor as modified for data warehousing projects. The general characteristic has associated descriptions that may help determine the degrees of influence of the characteristics ranging from 0 to 5. The range is implementation dependent and other ranges may be used. The range 0 to 5, for example, may indicate the degree of influence ranging from 0 to 5—rating 5 being the highest. For example, in any project the DB size may vary. If the DB size is 300-700 GB, the degree of influence may be indicated as 1 and if the size is 20 TB the degree of influence may be denoted as 5.

TABLE 1

| Sr. | General | |
|---|---|---|
| # | Characteristics | Description |
| 1. | Database Size | DB Bytes/Program SLOC |
| 2. | Distributed | Does system process data which may be distributed |
| | Data | across systems |
| | Processing | |
| 3. | Performance | Any specific requirement with regard to |
| | | performance? Need to make some design |
| | | considerations for the same? |
| 4. | Heavily Used | It may have more to do with, operational |
| | Configuration | restrictions/constraints. That is, security or timing |
| | | considerations etc. |
| 5. | Product/Project | It may be based on Control Operations, |
| | Complexity | Computational Operations, Data Management |
| | | Operations, and User Interface Management |
| | | Operations. |
| 6. | Required | This rating measures the schedule constraint |
| | Development | imposed on the project team developing the |
| | Schedule | software. The ratings may be determined in terms |
| | | of the percentage of schedule stretch-out or |
| | | acceleration with respect to a nominal schedule for |
| | | a project requiring a given amount of effort. |
| | | Accelerated schedules tend to produce more effort |
| | | in the later phases of development because more |
| | | issues are left to be determined due to lack of time |
| | | to resolve them earlier. A schedule compress of |
| | | 74% may be rated very low. A stretch-out of a |
| | | schedule produces more effort in the earlier phases |
| | | of development where there may be more time for |
| | | thorough planning, specification and validation. A |
| | | stretch-out of 160% may be rated very high. |
| 7. | Analyst | Analysts are personnel that work on requirements, |
| | Capability | high level design and detailed design. The major |
| | | attributes that may be considered in this rating are |
| | | Analysis and Design ability, efficiency and |
| | | thoroughness, and the ability to communicate and |
| | | cooperate. The rating may not consider the level of |
| | | experience of the analyst; that may be rated with |
| | | AEXP. Analysts that fall in the 15th percentile are |
| | | rated very low and those that fall in the 95th |
| | | percentile are rated as very high. |
| 8. | Programmer | Evaluation may be based on the capability of the |
| | Capability | programmers as a team rather than as individuals. |
| | | Major factors to be considered in the rating include |
| | | ability, efficiency and thoroughness, and the ability |
| | | to communicate and cooperate. The experience of |
| | | the programmer should not be considered here; it |
| | | may be rated with AEXP. A very low rated |
| | | programmer team may be in the 15th percentile |
| | | and a very high rated programmer team may be in |
| | | the 95th percentile. |
| 9. | Language and | This may be a measure of the level of |
| | Tool | programming language and software tool |
| | Experience | experience of the project team developing the |
| | | software system or subsystem. Software |
| | | development includes the use of tools that perform |
| | | requirements and design representation and |
| | | analysis, configuration management, document |
| | | extraction, library management, program style and |
| | | formatting, consistency checking, etc. In addition |
| | | to experience in programming with a specific |
| | | language the supporting tool set also effects |
| | | development time. A low rating may be given for |
| | | experience of less than 2 months. A very high |
| | | rating may be given for experience of 6 or more |
| | | years. |
| 10. | Reusability | Whether system may be being designed to |
| | | “generate” re-usable components. If yes, the |
| | | degree of re-usability may be high. |
| 11. | Installation Use | Conversion and installation requirements may be |
| | | stated by the user and conversion and installation |
| | | guides may be provided and tested. The impact of |
| | | conversion of the project may not be considered to |
| | | be important, or any other installation |
| | | requirements. |
| 12. | Application | This rating may be dependent on the level of |
| | Experience | applications experience of the project team |
| | | developing the software system or subsystem. The |
| | | ratings may be determined in terms of the project |
| | | team's equivalent level of experience with this type |
| | | of application. A very low rating may be for |
| | | application experience of less than 2 months. A |
| | | very high rating may be for experience of 6 years |
| | | or more. |
| 13. | Platform | The Post-Architecture model may broaden the |
| | Experience | productivity influence of PEXP, recognizing the |
| | | importance of understanding the use of more |
| | | powerful platforms, including more graphic user |
| | | interface, database, networking, and distributed |
| | | middleware capabilities. |
| 14. | Multiple Sites | Needs of multiple sites may be considered in the |
| | | design and the application may be designed to |
| | | operate only under similar hardware and software |
| | | environments, or less or more. |

The following are examples of implementations of the tool.

Case-1: ADM Marts Health Checks

The first exemplary project incorporates the Health Check processes put in place to diagnose the ‘health’ of the table load jobs for an Acquisitions Data Mart (ADM). The health check job performs completion of the table of load jobs, load job dependencies, and source and target table row count comparisons. Successful completion of table load jobs means that health checks may be performed only for ADM tables that were loaded successfully. Load job dependencies relates to the health check verifying that an ADM table is loaded only after the source driver table from ADM Staging has been loaded successfully. Also, when an “Evaluation_Reference” table which is a helper table is required for a given ADM table load, the load job dependency health check may verify that the “Evaluation_Reference” table was loaded prior to the ADM table load. Source and target table row count comparisons relate to the health check comparing the insert and update row count between an ADM table and the source driver table in ADM Staging to determine whether the counts match for the load run date being examined.

The Health Checks take the source and target counts for twenty-eight tables and then update two statistics tables: 1) Table_load_Run, and 2) Table_Load. To get the target and source counts, at least 2-3 source/target tables per table may be joined.

TABLE 2
Technology and Productivity

| Attribute | Value |
|---|---|
| Technology | PL/SQL |
| Productivity | 9 FP/Person Month |
| Person Month | 160 Person Hours |

In the estimation steps, for the transaction Function Points, since the two statistics tables are only updated by the Health check process, there are no EI's. Only four columns in table_Load and Table_Load_Run tables need to be updated by the Health Checks and therefore two logical groups of DET's and FTR's are considered:

TABLE 3

| | | | | | Unadjusted |
|---|---|---|---|---|---|
| | | | | | Function |
| Sno | NAME | DETS | FTR | F.COMPLEXITY | Points |
| 1 | Update into | 4 | 1 | LOW | 4 |
| | Table Load | | | | |
| | Run tables | | | | |
| 2 | Update into | 4 | 1 | LOW | 4 |
| | Table Load | | | | |
| | table | | | | |

Regarding EQ, for twenty-eight tables that needed Health Checks, it was needed to join two to three source and target tables to get the source and target count. So for twenty-eight tables the tool may take an average of 5 DET's and 1 logical FTR to end up with 140 DET's and 28 FTR's. Also there was one table that needed a special logic for eliminating the duplicates. The table had 5 relevant columns.

TABLE 4

| | | | | | Unadjusted |
|---|---|---|---|---|---|
| | | | | F. | Function |
| Sno | NAME | DETS | FTR | COMPLEXITY | Points |
| 1 | Counts for | 140 | 28 | HIGH | 6 |
| | Source and | | | | |
| | Target tables | | | | |
| 2 | Logic for | 5 | 1 | LOW | 3 |
| | Eliminating the | | | | |
| | Duplicates | | | | |

For the data Function Points, regarding ILF, in this example only four columns in each of the statistics tables, Table_Load and Table_Load_Run, need to be maintained which leads to a Low rating for ILF.

TABLE 5

| | | | | | Unadjusted |
|---|---|---|---|---|---|
| | | | | | Function |
| Sno | NAME | DETS | RETS | F.COMPLEXITY | Points |
| 1 | Table Load | 8 | 2 | LOW | 7 |
| | & Table | | | | |
| | Load Run | | | | |
| | Updates | | | | |

Regarding EIF, in this example all the Source and Target tables may have been taken care of in the estimation during the Build of the Marts, so the tool does not take any EIF's into account.

Adding up these Function points the tool arrives at the following:

TABLE 6
COMPLEXITY CONTRIBUTION

| | FUNCTION | | | | |
|---|---|---|---|---|---|
| FUNCTION TYPE | COMPLEXITY | NO'S | UFP | COMPLEXITY TOTAL | |
| ILF | LOW | 1 | 7 | 7 | |
| | AVERAGE | 0 | 10 | 0 | |
| | HIGH | 0 | 15 | 0 | |
| | | | | TOTAL | 7 |
| EIF | LOW | 0 | 5 | 0 | |
| | AVERAGE | 0 | 7 | 0 | |
| | HIGH | 0 | 10 | 0 | |
| | | | | TOTAL | 0 |
| EI | LOW | 0 | 3 | 0 | |
| | AVERAGE | 0 | 4 | 0 | |
| | HIGH | 0 | 6 | 0 | |
| | | | | TOTAL | 0 |
| EO | LOW | 2 | 4 | 8 | |
| | AVERAGE | 0 | 5 | 0 | |
| | HIGH | 0 | 7 | 0 | |
| | | | | TOTAL | 8 |
| EQ | LOW | 1 | 3 | 3 | |
| | AVERAGE | 0 | 4 | 0 | |
| | HIGH | 1 | 6 | 6 | |
| | | | | TOTAL | 9 |

| | |
|---|---|
| UNADJUSTED FUNCTION POINT COUNTS | 24 |

The Unadjusted Function Point (UFP)=24. Considering the Value Adjustment Factor, the fourteen modified General Characteristics, each accorded a specific degree of influence and the Total degree of influence as follows:

TABLE 7

| GENERAL SYSTEM | DEGREES OF |
|---|---|
| CHARECTERISTICS | INFLUENCE |
| DATABASE SIZE | 1 |
| DISRIBUTED DATAPROCESSING | 0 |
| PERFORMANCE | 1 |
| HEAVILY USED CONFIGURATION | 0 |
| PRODUCT/PROJECT COMPLEXITY | 1 |
| REQUIRED DEVLOPMENT | 0 |
| SCHEDULE | |
| ANALYST CAPABILITY | 1 |
| PROGRAMMER CAPABILITY | 1 |
| LANGUAGE AND TOOL EXPERIENCE | 1 |
| REUSABILITY | 0 |
| INSTALLATION USE | 0 |
| APPLICATION EXPERIENCE | 0 |
| PLATFORM EXPERIENCE | 0 |
| MULTIPLE SITES | 0 |
| TOTAL DEGREE OF INFLUENCE | 6 |

VAF=0.65+(Degree of Influence/100) EQUATION 4:

VAF=0.65+(6/100)=0.71 EQUATION 5:

AFP Adjusted Function Point=UFP*VAF EQUATION 6:

AFP=24*0.71=17.04 EQUATION 7:

Effort=Size (FP's)/Productivity (FP's per Person Month) EQUATION 8:

Effort=17.04/9=1.893 Person Months 302.93 Person Hours. EQUATION 9:

Using the tool to employ the FP method of estimation, the estimate for this project sums up to approximately to 303 Person Hours. The Actual time taken for completion of this project was 335 Person Hours. The Variance with reference to Actual Hours is (335−303)/335=9.5%.

Case-2: OBBT Audit Reports

In a second example, a project may intend to incorporate the OBBT Model with an existing Infrastructure Model Deployment Project. The goal of the project may be to automate audit report SAS programs developed for OBBT models, 7 sas scripts. The jobs may be run on a last day of every month such as scheduled through TIVOLI. The execution of SAS programs may be automated using UNIX shell scripts.

TABLE 8
Technology and Productivity

| Attribute | Value |
|---|---|
| Technology | Unix Scripting |
| Productivity | 19 FP/Person Month |
| Person Month | 160 Person Hours |

In the estimation steps, for transaction Function Points, since there are no new columns to be added/updated to the existing table there are no EI's. Regarding EO's, there may be six SAS scripts corresponding to the OOBT Model. These SAS programs include wrapper scripts. The data is loaded into flat files that are then merged with Platform Dataset. At the end there is Health Check to compare counts between the Files and Cycle_Model_Score table in OIS. There are no queries and as such no EQ's.

TABLE 9

| | | | | | Un- |
|---|---|---|---|---|---|
| | | | | | adjusted |
| | | | | F. | Function |
| Sno | NAME | DETS | FTR | COMPLEXITY | Points |
| 1 | SAS Wrapper (6) | 10 | 1 | LOW | 4 |
| 2 | Extract OBBT | 10 | 1 | LOW | 4 |
| | Model Wrapper | | | | |
| 3 | SQL Loader | 12 | 1 | LOW | 4 |
| | Scripts | | | | |
| | (5 Flat File s) | | | | |
| | Validating all the | | | | |
| | data files and | | | | |
| | loading | | | | |
| | using SQL | | | | |
| 4 | Loader. | 4 | 1 | LOW | 4 |
| 5 | Health Check | 12 | 1 | LOW | 4 |

Regarding data Function Points, for ILF, a Cycle_Model_Score table already exists therefore ILF is not taken into account. Regarding EIF, since Cycle_Model_Score table already exists, the EIF is not taken into account. Adding up these Function points, the tool arrives at the following:

TABLE 10
COMPLEXITY CONTRIBUTION

| | FUNCTION | | | | |
|---|---|---|---|---|---|
| FUNCTION TYPE | COMPLEXITY | NO'S | UFP | COMPLEXITY TOTAL | |
| ILF | LOW | 0 | 7 | 0 | |
| | AVERAGE | 0 | 10 | 0 | |
| | HIGH | 0 | 15 | 0 | |
| | | | | TOTAL | 0 |
| EIF | LOW | 0 | 5 | 0 | |
| | AVERAGE | 0 | 7 | 0 | |
| | HIGH | 0 | 10 | 0 | |
| | | | | TOTAL | 0 |
| EI | LOW | 0 | 3 | 0 | |
| | AVERAGE | 0 | 4 | 0 | |
| | HIGH | 0 | 6 | 0 | |
| | | | | TOTAL | 0 |
| EO | LOW | 5 | 4 | 20 | |
| | AVERAGE | 0 | 5 | 0 | |
| | HIGH | 0 | 7 | 0 | |
| | | | | TOTAL | 20 |
| EQ | LOW | 0 | 3 | 0 | |
| | AVERAGE | 0 | 4 | 0 | |
| | HIGH | 0 | 6 | 0 | |
| | | | | TOTAL | 0 |

| | |
|---|---|
| UNADJUSTED FUNCTION POINT COUNTS | 20 |

The Unadjusted Function Point (UFP)=20. To determine the Value Adjustment Factor, the 14 modified General Characteristics may be considered and each accorded a specific degree of influence to arrive at a total degree of influence as illustrated in the following table.

TABLE 11

| GENERAL SYSTEM | DEGREES OF |
|---|---|
| CHARECTERISTICS | INFLUENCE |
| DATABASE SIZE | 1 |
| DISRIBUTED DATAPROCESSING | 0 |
| PERFORMANCE | 1 |
| HEAVILY USED CONFIGURATION | 0 |
| PRODUCT/PROJECT COMPLEXITY | 1 |
| REQUIRED DEVLOPMENT | 0 |
| SCHEDULE | |
| ANALYST CAPABILITY | 1 |
| PROGRAMMER CAPABILITY | 1 |
| LANGUAGE AND TOOL EXPERIENCE | 1 |
| REUSABILITY | 0 |
| INSTALLATION USE | 0 |
| APPLICATION EXPERIENCE | 0 |
| PLATFORM EXPERIENCE | 0 |
| MULTIPLE SITES | 0 |
| TOTAL DEGREE OF INFLUENCE | 6 |

VAF=0.65+(Degree of Influence/100) EQUATION 10:

VAF=0.65+(6/100)=0.71 EQUATION 11:

AFP Adjusted Function Point=UFP*VAF EQUATION 12:

AFP=20*0.71=14.2 EQUATION 13:

Effort=Size (FP's)/Productivity (FP's per Person Month) EQUATION 14:

Effort=14.2/19=0.747 Person Months 119.57 Person Hours. EQUATION 15:

Employing the tool with the FP method of estimation, the estimate for this project sums up approximately to 119 Person Hours. The Actual time for completion of this project was 116 Person Hours. The Variance with reference to Actual Hours is=(116−119)/116=2.5%.

Case-3: Prime Rate Ph1

For example, a project may intend creating/modifying the Lookup tables in ODA and to support fulfillment of the requirements of a project. Tables 12 below illustrates the respective technologies. The project may involve loading new reference or lookup tables in ODA through Informatica Mapping; Interest_Index_Change and Interest_Index tables; Finance_Charge_Option and Finance_Charge_Option_Change tables; changes to the strategy for loading ODA Account table using PL/SQL; Full Load of the ODA Credit_Card table (i.e. load all accounts, not just COBRAND accounts) using Informatica and PL/SQL; accommodate DDL Changes to the OIS Account table using Informatica; and accommodate DDL Changes to the OIS Cycle_Account table using Informatica.

TABLE 12
Technology and Productivity

| Attribute | Value |
|---|---|
| Technology | PL/SQL |
| Productivity | 9 FP/Person Month |
| Technology | Informatica |
| Productivity | 19 FP/Person Month |
| Person Month | 160 Person Hours |

In the estimation steps, four new lookup tables may be formed as a result of which there may be two logical groupings of EI's. Also, one group may be considered for the addition of a column to Account and Cycle_Account tables.

TABLE 13

| | | | | | Un- |
|---|---|---|---|---|---|
| | | | | | adjusted |
| | | | | F. COM- | Function |
| Sno | NAME | DETS | FTR | PLEXITY | Points |
| 1 | Informatica Workflow | 7 | 1 | LOW | 3 |
| | for extracting | | | | |
| | data from TSYS for | | | | |
| | Interest_IndexLookup | | | | |
| | tables | | | | |
| 2 | Informatica Workflow | 7 | 1 | LOW | 3 |
| | for extracting data | | | | |
| | from TSYS for | | | | |
| | Finance_Charge | | | | |
| | Lookup tables | | | | |
| 3 | Adding 1 column to 2 | 6 | 1 | LOW | 3 |
| | informatica Workflows | | | | |
| | for Account and | | | | |
| | Cycle_Account | | | | |
| | tables in O/S | | | | |

Regarding EO, for the four new lookup tables, four individual groupings exist. Also, one other combination may be considered for the merge logic for Credit_Card table.

TABLE 14

| | | | | | |
|---|---|---|---|---|---|
| | | | | | Unadjusted |
| | | | | | Function |
| Sno | NAME | DETS | FTR | F. COMPLEXITY | Points |

| | | | | | |
|---|---|---|---|---|---|
| 1 | Loading Interest_Index_Change Table from the | 7 | 1 | LOW | 4 |
| | Staging table using a Informatica Workflow | | | | |
| 2 | Loading Interest_Index Table from the | 4 | 1 | LOW | 4 |
| | Interest_Index_Change using a Informatica | | | | |
| | Workflow | | | | |
| 3 | Loading Finance_Charge_Option_Change Table | 7 | 1 | LOW | 4 |
| | from the Staging table using a Informatica | | | | |
| | Workflow | | | | |
| 4 | Loading/Finance_Charge_OptionTable from the | 4 | 1 | LOW | 4 |
| | Finance_Charge_Option_Change using a | | | | |
| | Informatica Workflow | | | | |
| 5 | Inserting/Updating Credit_Card table in ODA | 14 | 1 | LOW | 4 |

Regarding EQ, pulling data from TSYS and loading into Staging table for Credit_Card tables may require two Logical groupings.

TABLE 15

| | | | | | Un- |
|---|---|---|---|---|---|
| | | | | | adjusted |
| | | | | F. | Function |
| Sno | NAME | DETS | FTR | COMPLEXITY | Points |
| 1 | Extarcting 14 | 14 | 1 | LOW | 3 |
| | columns from | | | | |
| | TSYS Table into | | | | |
| | the Staging table | | | | |
| | for Credit_Card | | | | |
| 2 | Creating a | 14 | 1 | LOW | 3 |
| | temporary table | | | | |
| | and eliminating | | | | |
| | the duplicate | | | | |
| | records | | | | |

Regarding the data Function Points, for ILF, since there are four new lookup tables, an effort is needed to maintain them.

TABLE 16

| | | | | F. | Un- |
|---|---|---|---|---|---|
| | | | | COM- | adjusted |
| | | | | PLEX- | Function |
| Sno | NAME | DETS | RETS | ITY | Points |
| 1 | Maintainenace of | 7 | 1 | LOW | 7 |
| | Interest_Index | | | | |
| | Lookup Tables | | | | |
| 2 | Maintainenace of | 7 | 1 | LOW | 7 |
| | Finance_Charge_option | | | | |
| | Lookup Tables | | | | |

Since all the Source and Target tables, except the Lookup tables that have been accounted for, already exist in this example project and may have been considered for estimation earlier, there are no EIF's.

Adding up these Function points provides the following:

TABLE 17
COMPLEXITY CONTRIBUTION

| | FUNCTION | | | | |
|---|---|---|---|---|---|
| FUNCTION TYPE | COMPLEXITY | NO'S | UFP | COMPLEXITY TOTAL | |
| ILF | LOW | 2 | 7 | 14 | |
| | AVERAGE | 0 | 10 | 0 | |
| | HIGH | 0 | 15 | 0 | |
| | | | | TOTAL | 14 |
| EIF | LOW | 0 | 5 | 0 | |
| | AVERAGE | 0 | 7 | 0 | |
| | HIGH | 0 | 10 | 0 | |
| | | | | TOTAL | 0 |
| EI | LOW | 3 | 3 | 9 | |
| | AVERAGE | 0 | 4 | 0 | |
| | HIGH | 0 | 6 | 0 | |
| | | | | TOTAL | 9 |
| EO | LOW | 5 | 4 | 20 | |
| | AVERAGE | 0 | 5 | 0 | |
| | HIGH | 0 | 7 | 0 | |
| | | | | TOTAL | 20 |
| EQ | LOW | 2 | 3 | 6 | |
| | AVERAGE | 0 | 4 | 0 | |
| | HIGH | 0 | 6 | 0 | |
| | | | | TOTAL | 6 |

| | |
|---|---|
| UNADJUSTED FUNCTION POINT COUNTS | 49 |

Thus Unadjusted Function Point (UFP)=49 (45 for Informatica+4 PL/SQL). The value+4 may be determined based on the requirement as mentioned in 00110 table 14 point no.5. The various requirements may have been coded in various technologies and this may have to be decided upon by the estimator. Considering the value adjustment factor with regard the fourteen modified general characteristics, each accorded a specific degree of influence and the total degree of influence may be arrived at as follows:

TABLE 18

| GENERAL SYSTEM | DEGREES OF |
|---|---|
| CHARECTERISTICS | INFLUENCE |
| DATABASE SIZE | 1 |
| DISRIBUTED DATAPROCESSING | 0 |
| PERFORMANCE | 1 |
| HEAVILY USED CONFIGURATION | 0 |
| PRODUCT/PROJECT COMPLEXITY | 1 |
| REQUIRED DEVLOPMENT | 0 |
| SCHEDULE | |
| ANALYST CAPABILITY | 1 |
| PROGRAMMER CAPABILITY | 1 |
| LANGUAGE AND TOOL EXPERIENCE | 1 |
| REUSABILITY | 0 |
| INSTALLATION USE | 0 |
| APPLICATION EXPERIENCE | 0 |
| PLATFORM EXPERIENCE | 0 |
| MULTIPLE SITES | 0 |
| TOTAL DEGREE OF INFLUENCE | 6 |

VAF=0.65+(Degree of Influence/100) EQUATION 16:

VAF=0.65+(6/100)=0.71 EQUATION 17:

AFP Adjusted Function Point=UFP*VAF EQUATION 18:

AFP=45*0.71+4*0.71=31.95+2.84 EQUATION 19:

Effort=Size (FP's)/Productivity (FP's per Person Month) EQUATION 20:

Effort=(31.95/19)+(2.84/9)=1.681+0.315=1.996 Person Months which is 319.44 Person Hours. EQUATION 21:

Therefore, employing the FP method of estimation, the estimate for this project sums up approximately to 320 Person Hours. The Actual time taken for completion of this project was 325 Person Hours. The variance with reference to actual hours is Variance=(325−320)/325=1.5%.

Case-4: 2_Prime_Rate Ph2—Health Checks

This example involves an extension of the 2 Prime_Rate Ph1 project and is intended at developing Health Checks for table 19 mentioned below, regarding Health Checks in ODA through Informatica Mapping; Interest_Index_Change and Interest_Index tables; Finance_Charge_Option and Finance_Charge_Option_Change tables; Health Check for ODA Account table using Informatical; and Health Check for ODA Account table using Informatica.

TABLE 19
Technology and Productivity

| Attribute | Value |
|---|---|
| Technology | Informatica |
| Productivity | 19 FP/Person Month |
| Person Month | 160 Person Hours |

For the estimation steps for transaction Function Points, since no new columns are being inserted/updated there are no EI's and no EO's. Regarding EQ, since all the Health Checks employ the similar strategy of comparing counts between the Source and Target, there are six separate combinations for all the tables.

TABLE 20

| | | | | | Unadjusted |
|---|---|---|---|---|---|
| | | | | | Function |
| Sno | NAME | DETS | FTR | F. COMPLEXITY | Points |
| 1 | Health Check for Interest_Index_Change Lookup | 2 | 1 | LOW | 3 |
| | Table | | | | |
| 2 | Health Check for Interest_Index Lookup Table | 2 | 1 | LOW | 3 |
| 3 | Health Check for Finance_Charge_Option_Change | 2 | 1 | LOW | 3 |
| | Lookup Table | | | | |
| 4 | Health Check for Finance_Charge_Option | 2 | 1 | LOW | 3 |
| | Lookup Table | | | | |
| 5 | Health Check for Credit_Card table in ODA | 4 | 1 | LOW | 3 |
| 6 | Health Check for Account table in ODA | 4 | 1 | LOW | 3 |

Regarding the data Function Points, since no new tables are being inserted/updated there are no ILF's and no EIF's.

Adding up these Function points, the following occurs:

TABLE 21
COMPLEXITY CONTRIBUTION

| | FUNCTION | | | | |
|---|---|---|---|---|---|
| FUNCTION TYPE | COMPLEXITY | NO'S | UFP | COMPLEXITY TOTAL | |
| ILF | LOW | 0 | 7 | 0 | |
| | AVERAGE | 0 | 10 | 0 | |
| | HIGH | 0 | 15 | 0 | |
| | | | | TOTAL | 0 |
| EIF | LOW | 0 | 5 | 0 | |
| | AVERAGE | 0 | 7 | 0 | |
| | HIGH | 0 | 10 | 0 | |
| | | | | TOTAL | 0 |
| EI | LOW | 0 | 3 | 0 | |
| | AVERAGE | 0 | 4 | 0 | |
| | HIGH | 0 | 6 | 0 | |
| | | | | TOTAL | 0 |
| EO | LOW | 0 | 4 | 0 | |
| | AVERAGE | 0 | 5 | 0 | |
| | HIGH | 0 | 7 | 0 | |
| | | | | TOTAL | 0 |
| EQ | LOW | 6 | 3 | 18 | |
| | AVERAGE | 0 | 4 | 0 | |
| | HIGH | 0 | 6 | 0 | |
| | | | | TOTAL | 18 |

| | |
|---|---|
| UNADJUSTED FUNCTION POINT COUNTS | 18 |

Therefore, the Unadjusted Function Point (UFP)=18. For the value adjustment factor regarding the fourteen modified General Characteristics, each accorded a specific degree of influence, the total degree of influence may be as follows:

TABLE 22

| GENERAL SYSTEM | DEGREES OF |
|---|---|
| CHARECTERISTICS | INFLUENCE |
| DATABASE SIZE | 1 |
| DISRIBUTED DATAPROCESSING | 0 |
| PERFORMANCE | 1 |
| HEAVILY USED CONFIGURATION | 0 |
| PRODUCT/PROJECT COMPLEXITY | 1 |
| REQUIRED DEVLOPMENT | 0 |
| SCHEDULE | |
| ANALYST CAPABILITY | 1 |
| PROGRAMMER CAPABILITY | 1 |
| LANGUAGE AND TOOL EXPERIENCE | 1 |
| REUSABILITY | 0 |
| INSTALLATION USE | 0 |
| APPLICATION EXPERIENCE | 0 |
| PLATFORM EXPERIENCE | 0 |
| MULTIPLE SITES | 0 |
| TOTAL DEGREE OF INFLUENCE | 6 |

VAF=0.65+(Degree of Influence/100) EQUATION 22:

VAF=0.65+(6/100)=0.71 EQUATION 23:

AFP Adjusted Function Point=UFP*VAF EQUATION 24:

AFP=18*0.71=12.78 EQUATION 25:

Effort=Size (FP's)/Productivity (FP's per Person Month) EQUATION 26:

Effort=12.78/19=0.672 Person Months 107.62 Person Hours. EQUATION 27:

Therefore, employing the Function Point method of estimation, the estimate for this project sums to approximately 107 Person Hours. The Actual time taken for completion of this project was 115 Person Hours. The variance with reference to Actual Hours is (115−107)/115=6.9%.

As may be evident from given case studies the estimated project size via Function Point may nearly approximate the actual size and effort, recording about a maximum deviation of 10%, and overall averaging around 5%. The deviation by industry standard falls within acceptable limits.

Moreover, taking into consideration the fact that the tool has not included any effort towards Project Management and Contingency, which normally is the case, then assuming the same (approximately 10%-12%), the estimates may ensure a near perfect fit too the actual estimates. Therefore, the tool may yield reliable, predictable and near accurate size estimates.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

We claim:

1. A method for estimating the size of a computer-related project, the method comprising:
quantifying transaction function points regarding transactions against files or data in the computer-related project;
quantifying data function points regarding files used to store data for the computer-related project;
calculating an unadjusted function point in accordance with the transaction function point and data function point;
determining a value adjustment factor as modified for a particular implementation;
calculating an adjusted function point in accordance with the unadjusted function point and the value adjustment factor; and
estimating the size of the computer-related project in accordance with the adjusted function point.

2. The method of claim 1, wherein the transaction function points comprise external inputs, external outputs, and external inquires of the computer-related project.

3. The method of claim 2, wherein the external inputs comprise a process in which data crosses a boundary from an outside of the boundary to an inside of the boundary.

4. The method of claim 2, wherein the external outputs comprise a process in which data crosses a boundary from an inside of the boundary to an outside of the boundary.

5. The method of claim 2, wherein the external inquiry comprises an elementary process with both input and output components that result in data retrieval from at least one of internal logical files and external interface files.

6. The method of claim 1, wherein the data function points denote internal logical files and external interface files.

7. The method of claim 6, wherein internal logical files comprise a user identifiable group of logically related data that resides within an application boundary and which is maintained through external inputs or external outputs.

8. The method of claim 6, wherein external interface files comprise a user identifiable group of logically related data used for reference purposes.

9. The method of claim 1 further comprising calculating effort as the adjusted function point divided by productivity.

10. The method of claim 1, wherein the size estimation comprises the size of a data warehouse project.

11. A project size estimation tool, comprising:
a processor to run computer executable code, wherein the computer executable code:
quantifies transaction function points regarding transactions against files or data in the computer-related project;
quantifies data function points regarding files used to store data for the computer-related project;
calculates an unadjusted function point in accordance with the transaction function point and data function point;
determines a value adjustment factor as modified for a particular implementation;
calculates an adjusted function point in accordance with the unadjusted function point and the value adjustment factor; and
estimates the size of the computer-related project in accordance with the adjusted function point.

12. The tool of claim 11, wherein the transaction function points comprise external inputs, external outputs, and external inquires of the computer-related project.

13. The tool of claim 12, wherein the external inputs comprise a process in which data crosses a boundary from an outside of the boundary to an inside of the boundary.

14. The tool of claim 12, wherein the external outputs comprise a process in which data crosses a boundary from an inside of the boundary to an outside of the boundary.

15. The tool of claim 12, wherein the external inquiry comprises an elementary process with both input and output components that result in data retrieval from at least one of internal logical files and external interface files.

16. The tool of claim 11, wherein the data function points denote internal logical files and external interface files.

17. The tool of claim 16, wherein internal logical files comprise a user identifiable group of logically related data that resides within an application boundary and which is maintained through external inputs or external outputs.

18. The tool of claim 16, wherein external interface files comprise a user identifiable group of logically related data used for reference purposes.

19. The tool of claim 11, wherein the computer executable code calculates effort as the adjusted function point divided by productivity.

20. The tool of claim 11, wherein the size estimation comprises the size of a data warehouse project.

21. A system for estimating the size of a computer-related project, the system comprising:
a first means for quantifying transaction function points regarding transactions against files or data in the computer-related project;
a second means quantifying data function points regarding files used to store data for the computer-related project;
a first calculating means being operatively coupled to the first and the second means for receiving the transaction function point and data function point and calculating an unadjusted function point;
a third means for determining a value adjustment factor as modified for a particular implementation;
a second calculating means being operatively coupled to the first calculating means and the third means for receiving the unadjusted function point and the value adjustment factor and calculating an adjusted function point; and
a fourth means for estimating the size of the computer-related project in accordance with the adjusted function point.

22. The system of claim 21 further comprising a means for receiving business requirement.

23. The system of claim 22, wherein the means for receiving the business requirement is operatively coupled to a means for estimating (a) number of data element types (DETs); (b) number of record element types (RETs) and (c) number of files updated or referenced (FTRs) from the business requirement thus received.

24. The system as claimed in claim 23, wherein the means for estimating is operatively coupled to (a) a means for classifying DETs and RETs into at least one type of transaction function point element and (b) a means for classifying DETs and FTRs into at least one type of data function point element.

25. The system of claim 24, wherein the transaction function point elements comprise external inputs, external outputs, and external inquires of the computer-related project.

26. The system of claim 25, wherein the external inputs comprise a process in which data crosses a boundary from an outside of the boundary to an inside of the boundary.

27. The system of claim 25, wherein the external outputs comprise a process in which data crosses a boundary from an inside of the boundary to an outside of the boundary.

28. The system of claim 25, wherein the external inquiry comprises an elementary process with both input and output components that result in data retrieval from at least one of internal logical files and external interface files.

29. The system of claim 24, wherein the data function point elements comprise internal logical files and external interface files.

30. The system of claim 29, wherein internal logical files comprise a user identifiable group of logically related data that resides within an application boundary and which is maintained through external inputs or external outputs.

31. The system of claim 29, wherein external interface files comprise a user identifiable group of logically related data used for reference purposes.

32. The system as claimed in claim 24, wherein the means for classifying DETs and RETs into at least one type of transaction function point element is operatively coupled to the means for quantifying transaction function points.

33. The system as claimed in claim 24, wherein the means for classifying DETs and FTRs into at least one type of data function point element is operatively coupled to the means for quantifying data function points.

34. The system of claim 21 further comprising means for calculating effort as the adjusted function point divided by productivity.

35. The system of claim 21, wherein the size estimation comprises the size of a data warehouse project.
